(19) United States
(12) Patent Application Publication
(10) Pub. No.: US 2023/0192522 A1
(43) Pub. Date: Jun. 22, 2023

(54) REMOVING WATER-SOLUBLE HEAVY METAL-SULFUR COMPLEX FROM PROCESS SOLUTION

(71) Applicant: Tessenderlo Kerley, Inc., Phoenix, AZ (US)

(72) Inventors: Scott W. WAITE, Tonopah, NV (US); Jorge FRANCO, Mesa, AZ (US); Paul Moran, Scottsdale, AZ (US); Constance Lynn Frank LOCKHART, Tucson, AZ (US)

(73) Assignee: Tessenderlo Kerley, Inc., Phoenix, AZ (US)

(21) Appl. No.: 17/917,265

(22) PCT Filed: Apr. 6, 2021
(86) PCT No.: PCT/US2021/025851

§ 371 Date: Oct. 6, 2022

Related U.S. Application Data
(60) Provisional application No. 63/006,440, filed on Apr. 7, 2020.

(51) Int. Cl. C02F 9/00

(52) U.S. Cl. CPC C02F 9/00; C02F 2101/101

(57) ABSTRACT

Methods for removing a soluble heavy metal-sulfur complex from a process solution comprise contacting the process solution with an oxidant to oxidize the heavy metal-sulfur complex and form an oxidized complex precipitate, or with an acid to acidify the heavy metal-sulfur complex and form an acidified complex precipitate, and removing the precipitate from the process solution to provide a heavy metal-reduced solution. The method is advantageous for removing heavy metals such as mercury, cadmium, barium, iron, vanadium and/or manganese from process solutions, for example originating from natural gas production, petroleum production, water treatment or mining.

### FIELD OF THE INVENTION

The present invention relates to methods for removing a soluble heavy metal-sulfur complex from a process solution. In specific embodiments, the invention relates to methods for removing heavy metals such as mercury, cadmium, barium, iron, vanadium, manganese and/or other heavy metals from process solutions originating from, for example, natural gas production, petroleum production, water treatment, and other industrial processes.

### BACKGROUND OF THE INVENTION

Heavy metals are often present in natural gas and oil reservoirs and therefore are often present in process streams during or resulting from production of natural gas and crude petroleum. In typical processes, such process streams are aqueous-based or glycol based. While the relative amounts of heavy metal may seem small, in the parts per billion (ppb) or parts per million (ppm) ranges, both by weight, such amounts of heavy metals can interfere with processing and/or contaminate desired products. In natural gas production, elemental mercury is typically encountered in process streams. In crude petroleum production, a variety of heavy metals, including, but not limited elemental mercury, cadmium, barium, iron, vanadium and manganese, are often encountered in process streams. Heavy metals like these are also sometimes present in water streams in water treatment processes and in other industrial processes.

Various methods have been disclosed for removing heavy metals from process streams, particularly in natural gas production or petroleum production. One common technique is to add a sulfide material to an aqueous process stream or a glycol process stream. For example, U.S. Pat. No. 4,915,818 discloses a method of removing mercury from a mercury-contaminated liquid hydrocarbon by contacting the hydrocarbon with an aqueous dilute solution of alkaline metal sulfide salts and separating a liquid hydrocarbon phase substantially free of mercury from the mixture of mercury-contaminated liquid hydrocarbon and aqueous dilute alkaline metal sulfide solution. U.S. Pat. No. 4,915,818 also discloses a method for removing mercury from a liquid hydrocarbon by emulsifying the liquid hydrocarbon with an aqueous solution of an alkaline metal polysulfide and separating a liquid hydrocarbon phase substantially free of mercury from the emulsified mixture. U.S. Pat. No. 4,551,237 discloses the use of an aqueous solution of sulfide materials to remove arsenic from oil shale. U.S. Pat. No. 9,199,898 discloses a process for removing heavy metals from hydrocarbon fluids such as a natural gas stream by injecting a hydrate inhibitor and a complexing agent into a pipeline wherein the complexing agent extracts volatile mercury from the natural gas and forms non-volatile mercury complexes in the produced water process stream. Suitable complexing agents include mercaptans, organic polysulfides, sulfanes, sulfides, hydrosulfides, and inorganic polysulfides, and combinations thereof.

While such methods are effective for removing heavy metals such as mercury from natural gas and crude petroleum products, they typically result in the formation of aqueous and/or glycol process streams containing the heavy metals in the form of soluble and suspended sulfur complexes. Processing of such streams to remove the heavy metals or proper disposal of such streams is then required. Often, such process streams contain the heavy metal in a soluble form, for example, as a water-soluble and/or glycol-soluble mercury-sulfur complex in an aqueous or glycol process solution. U.S. Pat. No. 9,199,898 discloses that mercury compounds in such process streams can be removed by contacting the stream with absorbent particles or with an ion exchange resin. However, the amounts of heavy metal compounds in such process streams are relatively high and often exceed the capacity of a reasonably-sized absorbent or resin bed to effectively remove the heavy metals without frequent change outs of the absorbent or resin bed and/or bleed through of the heavy metals. Accordingly, there is a need for improved methods to remove heavy metals, particularly mercury, from such aqueous and glycol process streams, and, as the production of natural gas increases worldwide, the need for such methods is increased.

### SUMMARY OF THE INVENTION

It is therefore an object of the present invention to provide improved methods for removing a soluble heavy metal-sulfur complex from a process solution.

In one embodiment, the invention is directed to a method for removing a soluble heavy metal-sulfur complex from an aqueous or glycol process solution.

In an embodiment, the method comprises contacting the process solution with an oxidant to oxidize the heavy metal-sulfur complex and form an oxidized complex precipitate, and removing the precipitate from the process solution to provide a heavy metal-reduced process solution. In specific embodiments, an oxygen-containing oxidant is employed. In another embodiment, the method comprises contacting the process solution with an acid, preferably a weak acid, to precipitate the heavy metal-sulfur complex and form an acidified complex precipitate, and removing the precipitate from the process solution to provide a heavy metal-reduced process solution.

In other words, there is provided a method for removing a soluble heavy metal-sulfur complex from an aqueous or glycol process solution comprising the steps of:

(i)a contacting the process solution with an oxidant to oxidize the heavy metal-sulfur complex and form an oxidized complex precipitate; and/or
(i)b contacting the process solution with an acid, preferably a weak acid, to precipitate the heavy metal-sulfur complex and form an acidified complex precipitate; and
(ii) removing the precipitates from the process solution to provide a heavy metal-reduced process solution.

In particularly preferred embodiments of the process, step (i)a is performed and step (i)b is not performed. In other embodiments of the process, step (i)a is not performed and step (i)b is performed. In other embodiments of the process, step (i)a and step (i)b are both performed. In such embodiments, step (i)a and step (i)b may be performed in any order, and may be performed partially or completely simultaneously.

In more specific embodiments of the methods of the invention, the contacting step (i)a comprises sparging with an oxidant, for example, air and/or oxygen sparging, which provides an elegant solution for removing a soluble heavy metal-sulfur complex from an aqueous or glycol process solution.

In a more specific embodiment, the invention is directed to a method for removing a soluble mercury-sulfur complex from an aqueous or glycol process solution.

In an embodiment, the method comprises contacting the process solution with an oxidant to oxidize the mercury-sulfur complex and form an oxidized complex precipitate, and removing the precipitate from the process solution to provide a mercury-reduced process solution. In specific embodiments, an oxygen-containing oxidant is employed.

In another embodiment, the method comprises contacting the process solution with an acid, preferably a weak acid, to precipitate the heavy metal-sulfur complex and form an acidified complex precipitate, and removing the precipitate from the process solution to provide a mercury-reduced process solution.

In other words, there is provided a method for removing a soluble mercury-sulfur complex from an aqueous or glycol process solution comprising the steps of:

(i)a contacting the process solution with an oxidant to oxidize the mercury-sulfur complex and form an oxidized complex precipitate; and/or
(i)b contacting the process solution with an acid, preferably a weak acid, to precipitate the mercury-sulfur complex and form an acidified complex precipitate; and
(ii) removing the precipitates from the process solution to provide a mercury-reduced process solution.

In particularly preferred embodiments of the process, step (i)a is performed and step (i)b is not performed. In other embodiments of the process, step (i)a is not performed and step (i)b is performed. In other embodiments of the process, step (i)a and step (i)b are both performed. In such embodiments, step (i)a and step (i)b may be performed in any order, and may be performed partially or completely simultaneously.

The methods of the invention are advantageous in providing an efficient and inexpensive means for removing heavy metals from process streams. The methods are suitable for use with process streams encountered in processing natural gas and crude petroleum products, in water treatment processes, and in other industrial processes. These and additional advantages are further apparent from the detailed description.

### DETAILED DESCRIPTION

In one embodiment, the invention is directed to a method for removing a soluble heavy metal-sulfur complex from a process solution. While certain embodiments of the invention are described below with respect to removal of a soluble mercury-sulfur complex from an aqueous process stream in natural gas production, the invention also encompasses, and the described specific embodiments are applicable to, methods for removal of other soluble heavy metal-sulfur complexes from process streams in natural gas production, crude petroleum production, water treatment, mining, for example, mining of non-precious metals, and other industrial process streams. Thus, in additional embodiments, soluble heavy metal-sulfur complexes comprising one or more sulfide complexes of elemental mercury, cadmium, barium, iron, vanadium and/or manganese are removed from a process solution.

In one embodiment, the process solution containing a soluble heavy metal-sulfur complex is an aqueous process solution. The methods are suitable for use with aqueous process solutions having a wide range of water content. In specific embodiments, the methods are suitable for use with aqueous process solutions having a water content of from about 1 to about 99 wt % water, from about 1 to about 90 wt % water, from about 1 to about 80 wt % water, from about 1 to about 50 wt % water, from about 1 to about 40 wt % water, from about 1 to about 25 wt % water, from about 25 to about 99 wt % water, or from about 50 to about 99 wt % water.

In another embodiment, the process solution containing a soluble heavy metal-sulfur complex is a glycol process solution. Often a glycol stream is used in natural gas production to dehydrate the natural gas. Various glycols are suitable for use in such processes and typically comprise triethylene glycol (TEG), diethylene glycol (DEG), monoethylene glycol (MEG), and/or tetraethylene glycol (TTEG). In a specific embodiment, the glycol process solution comprises TEG. The methods are suitable for use with glycol process solutions having a wide range of glycol content. In specific embodiments, the methods are suitable for use with glycol process solutions having a glycol content of from about 1 to about 99 wt % glycol, from about 25 to about 99 wt % glycol, from about 40 to about 95 wt % glycol, from 50 to about 95 wt % glycol, or from 60 to about 95 wt % glycol. As such glycol solutions are typically used to dehydrate natural gas, the glycol solutions typically also include water, i.e., water which has been removed from the natural gas. The dehydration may also bring water-soluble heavy metal contaminants, including mercury, into the glycol solution, and the resulting glycol solution containing such contaminates are suitably treated according to the inventive methods.

Natural gas sources typically contain low molecular weight hydrocarbons such as methane, ethane, propane, and other hydrocarbons that are gases at room temperature. Elemental mercury is present in natural gas as volatile mercury. Natural gas sources typically also contain at least a small amount of water, for example, at least about 0.1 vol % of water, at least about 1 vol % water, or at least about 2 vol % water, although some natural gas sources contain appreciable amounts of water of 50 vol % or more. Moreover, as noted previously, a common technique to remove heavy metals such as mercury comprises addition of a sulfur material to a process stream to complex with the elemental mercury. Such sulfur materials are commonly added in an aqueous form. Whether the sulfur materials are added neat or in an aqueous form, the resulting process stream typically contains at least some water, inherently from the natural gas source and/or through addition of treatment materials.

Examples of sulfur materials which may be used as complexing agents for the removal of heavy metals such as elemental mercury, cadmium, barium, iron, vanadium or manganese, or, specifically, mercury, include, but are not limited to, mercaptans, organic polysulfides, for example, of the formula R—Sₓ—R′, wherein S is sulfur, x is greater than 1, and R and R′ are independently selected from alkyl and aryl groups, sulfanes, for example, of the formula H₂Sₓ, where x is greater than 1, water-soluble sulfur materials, for example, sulfides, hydrosulfides, and inorganic polysulfides, for example, of the formula M—Sₓ—M, where x is greater than 1 and M is an alkaline metal, alkaline earth metal, and/or ammonium, and combinations of two or more thereof. Such sulfur materials extract volatile heavy metals, including volatile elemental mercury, in natural gas into the liquid phase by forming non-volatile heavy metal-sulfur complexes. Examples of non-volatile heavy metal complexes can include precipitates, but more commonly comprise water-soluble heavy metal-sulfur compounds. In specific embodiments, such sulfur materials extract volatile elemental mercury in natural gas into the liquid phase by forming non-volatile mercury-sulfur complexes. Examples of non-volatile mercury complexes can include precipitates, but more commonly comprise water-soluble mercury-sulfur compounds.

In a specific embodiment, the process solutions which are employed in the methods of the invention are formed by addition of one or more inorganic polysulfides to a natural gas or crude petroleum production process stream for heavy metal removal. In a more specific embodiment, the process solutions which are employed in the methods of the invention are formed by addition of one or more inorganic water-soluble polysulfides to an aqueous or glycol process stream to complex with the heavy metal to form water-soluble or glycol-soluble complexes. Typically, one or more alkaline polysulfides and/or one more alkaline earth polysulfides, and/or one or more ammonium polysulfides, or, more specifically, polysulfide salts, may be employed. Thus, in specific embodiments, the polysulfide composition may comprise mixtures of two or more different polysulfide salts, including mixtures of different alkaline polysulfides, mixtures of different alkaline earth polysulfides, mixtures of different ammonium polysulfides, and/or mixtures of any two or more selected from alkaline polysulfides, alkaline earth polysulfides, and ammonium polysulfides.

Alkaline and ammonium polysulfides are typically of the formula M—Sₓ—M, wherein S is sulfur, M is independently selected from alkaline metal ions such as sodium and/or potassium, and/or ammonium ions, more specifically, sodium ions, where x is greater than 1. In more specific embodiments, x is an integer from 2 to 5, or, more specifically, from 2 to 4. In further embodiments, x may vary in a polysulfide material and, in specific embodiments, the average x in such polysulfides is from 3.5 to 5, or, more specifically, from 3.5 to 4.5.

Alkaline earth polysulfides are typically of the formula M—Sₓ, wherein S is sulfur, M is independently selected from alkaline earth ions such as calcium and magnesium, and x is greater than 1. More specifically, x is an integer from 2 to 6 or, more specifically, from 3 to 6. In further embodiments, x may vary in a polysulfide material and, in specific embodiments, the average x in such polysulfides is from 3 to 5, or, more specifically, from 4 to 5.

Specific polysulfides include calcium polysulfides, magnesium polysulfides, sodium polysulfides, potassium polysulfides, ammonium polysulfides, and mixtures of any two or more of these. More specific embodiments employ calcium polysulfides and/or sodium polysulfides and/or potassium polysulfides, or, more specifically, sodium polysulfides and/or potassium polysulfides. In yet more specific embodiments, an aqueous process stream or a glycol process stream comprises a heavy metal complex, or, specifically, a mercury complex, with one or more sodium polysulfides, one or more potassium polysulfides, or one or more calcium polysulfides.

The amount of sulfur complexing agent which is added for heavy metal removal, or, specifically, for mercury removal, is determined by the effectiveness of complexing agent employed. The amount is at least sufficient to provide an equimolar ratio of sulfur to heavy metal, specifically, mercury, in the process stream, i.e., in a natural gas stream, if not in an excess amount. In one embodiment, the molar ratio ranges from 2:1 (mol sulfur in the complexing agent:mol mercury) to 10,000:1. In another embodiment, the molar ratio of sulfur in the complexing agent:mol heavy metal/mercury ranges from 10:1 to 5000:1. In yet another embodiment, the molar ratio of sulfur in the complexing agent:mol heavy metal/mercury ranges ranging from 50:1 to 2500:1. In additional embodiments, wherein the process stream is an aqueous process stream, the amount of complexing agent added is limited to 5 vol. % or less of the water phase in the process stream, or less than 2 vol. % of the water phase in the process stream. In additional embodiments, the complexing agents are employed in a sufficient amount to provide a sulfide concentration ranging from 0.01 M to 10 M, from 0.02 M to 5 M, from 0.03 M to 4 M, or from 0.05 M to 4 M.

With the addition of complexing agent to the process stream, volatile heavy metals, or, specifically, mercury, are extracted from the gas phase into the liquid phase, i.e., water and/or glycol phase, to provide a gas phase having a reduced concentration of heavy metals. Typically, in a natural gas process stream, the original mercury level in the natural gas phase is reduced by at least 50 wt %, and often is reduced by at least 75%, and in some cases, by at least 90% or more. The mercury content in the aqueous phase conversely is increased.

The heavy metal-reduced gaseous phase and the heavy metal enriched aqueous phase are separated, resulting in a process solution containing a soluble heavy metal-sulfur complex. The inventive methods allow for removal of the complex in an efficient manner, particularly on an industrial scale.

In step (i)a of the process, the process solution containing a soluble heavy metal-sulfur complex is contacted with an oxidant to oxidize the heavy metal-sulfur complex and form an oxidized complex precipitate. Suitable oxidants for use in the present methods include both inorganic oxidants and organic oxidants. In a specific embodiment, the oxidant contains oxygen. In another specific embodiment, the oxidant supplies reactive oxygen to the process solution. In another embodiment, the oxidant is in gaseous form. Exemplary oxidants include, but are not limited to, oxygen, ozone, air, organic peroxides, including, but not limited to ketone peroxides, inorganic peroxides, including, but not limited to, hydroperoxides such as hydrogen peroxide, persulfates, permanganates, bromine, bromates, chlorine, chlorinated isocyanurates, chlorates, hypochlorites, chromates, dichromates, nitrates, nitric acid, nitrites, perborates, perchlorates, perchloric acid, periodates, peroxyacids, and the like. The oxidant is employed in an amount sufficient to oxidize the heavy metal-sulfur complex and form an oxidized complex precipitate which may then be removed from the process solution to provide a heavy metal-reduced process solution.

In step (i)a of the process, the process solution containing a soluble heavy metal-sulfur complex may be contacted with the oxidant using one or more of a variety of techniques known in the art. For example, the process solution can be contacted by one or more conventional processes and/or equipment known in the art, including, but not limited to, contact using a pressure reactor (batch, semi-batch, and/or continuous), for example, a stirred tank reactor with one or more impellers or other stirring-type agitators, turbine/gas entrainment turbine, for example, Rushton, Smith, Bakker, pitch blade, flat blade disc, wide foil, or the like, inline high shear and high impacting mixing equipment such as bubble columns, packed columns, tray columns, spray columns, jet loops, pipes/tubes and tanks with cavitation technology such as a cavitation propeller or distributor, a cavitation pump, a tubular reactor, sparging, or the like. In a specific method, the contacting of step (i)a includes sparging of an oxidant through the process stream.

In step (i)a of the process, the oxidant may be contacted with the process solution in gaseous form, for example, as air and/or oxygen gas. Alternatively, the oxidant can be added to the process solution in the form of a solid or liquid, for example, with mixing via any of the methods/equipment described previously, to improve contact of the oxidant and the heavy metal-sulfur complex throughout the process solution. The amount of oxidant which is contacted with the process solution is effective to oxidize the water-soluble heavy metal-sulfur complex and form an oxidized precipitate. For example, in a specific embodiment, the oxidant is employed in an amount sufficient to provide a ratio of at least one mole of oxygen per mole of sulfur in the process solution. In more specific embodiments, the oxidant is employed in an amount sufficient to provide a ratio of at least approximately 1.2 moles of oxygen to one mole of sulfur in the process solution.

In specific embodiments wherein step (i)a is performed, the process solution comprises a mercury-sulfur complex and is contacted with an oxidant such as air, oxygen, ozone, hydrogen peroxide, or other inorganic peroxide to form a precipitated oxidized mercury-sulfur complex.

In step (i)b of the process, the process solution containing a soluble heavy metal-sulfur complex is contacted with an acid to acidify the heavy metal-sulfur complex and form an acidified complex precipitate. Suitable acids include strong and weak acids, including mineral acids and organic acids. The present inventors have surprisingly found that while strong acids work to remove the heavy metal-sulfur complex from the process solution, precipitation formation is significantly improved when using weak acids. Hence, preferably the acid employed in step (i)b is a weak acid. While the invention is not particularly limited with regard to the identity of the weak acid, in general weak acids having a molecular weight of less than 300 g/mol are preferred when considering solubility as well as cost-efficiency. Preferred weak acids for use in step (i)b of the process have a pKa of less than 12, preferably a pKa in the range of 3-11, more preferably a pKa in the range of 3-8, most preferably a pKa in the range of 3.5-6. A polyprotic acid is considered to have the recited pKa if at least one of its acid-base equilibria has the recited pKa. Hence, the weak acid preferably has the pKa characteristics recited herein as well as a molecular weight of less than 300 g/mol.

In preferred embodiments of the invention, the acid employed in step (i)b is selected from the group consisting of carboxylic acids, phenols, sulfonic acids, carbonic acid, ammonium salts, sulfurous acid, phosphoric acid, dihydrogen phoshates, hydrogen phosphates, boric acid, bisulfates, nitrous acid and combinations thereof. Hence, in highly preferred embodiments, the acid employed in step (i)b is selected from the group consisting of carboxylic acids, phenols, sulfonic acids, carbonic acid, ammonium salts, sulfurous acid, bisulfites, phosphoric acid, dihydrogen phoshates, hydrogen phosphates, boric acid, bisulfates, nitrous acid and combinations thereof, and has the pKa characteristics recited herein as well as a molecular weight of less than 300 g/mol. The identity of the counterion when a weak acid is employed in the form of a salt (such as an ammonium salt, a dihydrogen phosphate, a hydrogen phosphate, a bisulfate or a bisulfite) is not particularly limited, and can be any of the conventional counterions known to the skilled person. Typical counterions for anionic weak acids (such as a dihydrogen phosphate, a hydrogen phosphate, a bisulfate or a bisulfite) are alkaline metal or alkaline earth metal ions (e.g. sodium or potassium), while typical counterions for cationic weak acids (such as ammonium salts), are halogens ions (e.g. chloride).

Examples of suitable weak acids employed in step (i)b are selected from the group consisting of acetic acid, carbonic acid, oxalic acid, hydrogen oxalate, citric acid, dihydrogen citrate, hydrogen citrate, fumaric acid, hydrogen fumarate, maleic acid, hydrogen maleate, succinic acid, hydrogen succinate, itaconic acid, hydrogen itaconate, p-toluenesulfonic acid, ammonium chloride, sulfurous acid, bisulfites, phosphoric acid, dihydrogen phoshates, hydrogen phosphates, boric acid, bisulfates, nitrous acid, formic acid, benzoic acid and combinations thereof, preferably selected from formic acid, citric acid, acetic acid, carbonic acid and combinations thereof. As will be understood by the skilled person, the carbonic acid will conventionally be formed in situ by providing CO₂ to the process solution. Hence, a step of providing CO₂to the process solution (in solid form or in gaseous form, for example employing any of the contacting methods described herein earlier for the oxidant) is thus explicitly considered to be a specific embodiment of step (i)b using carbonic acid. The carbonic acid is preferably provided by sparging CO₂ through the process stream.

The acid is preferably added to the process solution in an amount such that it causes a reduction in pH of the process solution by more than 2, preferably by more than 3. Hence, preferably step (i)b of the process comprises addition of a weak acid as described herein in an amount such that it causes a reduction in pH of the process solution by more than 2, preferably by more than 3. In some embodiments, in particular when a polysulfide was used to form the soluble heavy metal-sulfur complex, the process solution has a pH of 10 or more before step (i)b, and the process comprises addition of a weak acid as described herein in an amount such that it causes a reduction in pH of the process solution to pH 8 or less, preferably to pH 7.5 or less, more preferably to pH 7 or less.

The precipitated complex is then removed from the process solution using one or more of a variety of techniques known in the art to provide a heavy metal-reduced process solution. For example, the removing step may comprise one or more of filtration, i.e., macrofiltration, microfiltration and/or ultrafiltration, flotation, including, but not limited to, dissolved air flotation in which the precipitate is floated to the top of the solution and then skimmed off via a skimmer, thickening techniques, including, but not limited to, sedimentation, hydrocyclonic, cross flow filtration, and/or gravity techniques, membrane separation, field assisted separation, for example using a magnetic, electric, dielectric, and/or acoustic field, and/or centrifugation. Combinations of two or more of such techniques may also be employed.

As a result, the process solution contains a reduced amount of heavy metal, or, specifically, a reduced amount of mercury, as compared with the amount in the solution prior to the treatments of step (i)a and/or (i)b. In specific embodiments, dependent on, inter alia, the amount of oxygen and/or acid provided to the process solution, the heavy metal-reduced solution comprises less than about 80 wt %, less than about 85 wt %, less than about 90 wt %, less than about 95 wt %, or less than about 99 wt %, of the heavy metal contained in the process solution prior to the step of oxygen contact. In more specific embodiments, the heavy metal-reduced solution comprises less than about 5000 ppb heavy metal, less than about 4000 ppb heavy metal, less than about 3000 ppb heavy metal, less than about 2000 ppb heavy metal, or less than about 1000 ppb heavy metal.

In more specific embodiments, the process solution comprises mercury and the mercury-reduced solution comprises less than about 80 wt %, less than about 85 wt %, less than about 90 wt %, less than about 95 wt %, or less than about 99 wt % of the mercury contained in the process solution prior to the treatments of step (i)a and/or step (i)b. In more specific embodiments, the mercury-reduced solution comprises less than about 5000 ppb mercury, less than about 4000 ppb mercury, less than about 3000 ppb mercury, less than about 2000 ppb mercury, or less than about 1000 ppb mercury.

To the extent that the heavy metal, or, specifically, mercury, content of the reduced solution is still too high to properly dispose of or recycle the solution for reuse, the reduced solution may optionally be subjected to further purification steps, including, but not limited to, absorption or ion exchange. Owing to the relatively low content of heavy metals in the reduced solution, the amount of absorbent or ion exchange resin needed to reduce the heavy metals to an acceptable level is much less than that required in operations which do not include the oxidized precipitate formation and removal steps of the inventive methods. Thus, for example, an ion exchange resin bed of reasonable size and capacity may be used without as frequent of resin change out or risk of bleed through.

Those skilled in the art will appreciate that the process solution which is treated according to the present methods may include additional additives. For example, solid hydrates such as methane-water hydrates, carbon dioxide-water hydrates, and others, can easily form in natural gas process streams. Hydrate formation is undesirable as hydrates can restrict flow and lead to blockage in production lines. A thermodynamic inhibitor is therefore often included in process streams to depress hydrate formation and to decrease a temperature at which hydrates will form in the natural gas streams, for example, by 0.5 to about 30° C. Thus, in a specific embodiment, the process solution which is treated according to the inventive methods includes a thermodynamic inhibitor. Examples of suitable thermodynamic inhibitors include, but are not limited to, potassium formate, monoethylene glycol (MEG), a diethylene glycol, a triethylene glycol, a tetraethylene glycol, a propylene glycol, a dipropylene glycol, a tripropylene glycol, a tetrapropylene glycol, a polyethylene oxide, a polypropylene oxide, a copolymer of ethylene oxide and propylene oxide, a polyethylene glycol ether, a polypropylene glycol ether, a polyethylene oxide glycol ether, a polypropylene oxide glycol ether, a polyethylene oxide/polypropylene oxide glycol ether, a monosaccharide, a methylglucoside, a methylglucamine, a disaccharide, fructose, glucose, an amino acid, an amino sulfonate, methanol, ethanol, propanol, isopropanol, and combinations thereof. Thermodynamic inhibitors are typically included in an amount effective to reduce hydrate formation, which can be determined according to the natural gas stream composition and temperature. In specific embodiments, a thermodynamic inhibitor is included in an amount of 5 to 80 vol %, 20 to 70 vol %, or 30 to 60 vol % of the water in a natural gas process stream.

One or more additional hydrate inhibitor compounds may also be employed in natural gas process streams to further inhibit hydrate formation. Such hydrate inhibitors are capable of one or more of decreasing the rate of hydrate formation; preventing the hydrate forming reaction; and/or preventing formed hydrates from adhering to one another. Thus, in a specific embodiment, the process solution which is treated according to the inventive methods includes a hydrate inhibitor compound. Examples of hydrate inhibiting compounds include, but are not limited to, oxazolidinium compounds, tertiary amine salts, reaction products of non-halide-containing organic acids and organic amines, polymers having n-vinyl amide and hydroxyl moieties, dendrimeric or branched compounds, linear polymers and copolymers, grafted or branched linear polymers and copolymers, onium compounds, and combinations thereof. These hydrate inhibitors are typically used in an amount of 0.5 to 5.0 vol. % of the water present in a natural gas process stream.

As is known in the art, combinations of one or more thermodynamic inhibitors and one or more hydrate inhibitor compounds may also be employed and therefore, in a specific embodiment, the process solution which is treated according to the inventive methods includes a thermodynamic inhibitor and a hydrate inhibitor compound.

In further embodiments, at least one anti-foam agent is added to a natural gas process stream and therefore may be present in the process solution treated according to the present methods. The anti-foam agent prevents foam from forming and/or reduces the extent of foaming. Thus, some anti-foam agents may have both functions, e.g., reducing/mitigating foam formation under certain conditions, and preventing foam formation under other conditions. Anti-foam agents are known in the art and examples include, but are not limited to, silicones, for example, polydimethyl siloxane (PDMS), polydiphenyl siloxane, fluorinated siloxane, and the like. Typically, an anti-foam agent may be included in a natural gas process stream in an amount of from 1 to 500 ppm.

In further embodiments, at least one demulsifier is added to a natural gas process stream and therefore may be present in the process solution treated according to the present methods. Demulsifiers are known in the art and examples include, but are not limited to, polyamines, polyamidoamines, polyimines, condensates of o-toluidine and formaldehyde, quaternary ammonium compounds, ionic surfactants, polyoxyethylene alkyl phenols, their sulphonates and sodium sulphonates thereof, and polynuclear, aromatic sulfonic acids. Typically, a demulsifier may be included in a natural gas process stream in an amount of from 1 to 5,000 ppm, or from 10 to 500 ppm.

In further embodiments, at least one flocculation aid is added to the process solution, before and/or after the process solution is subjected to the treatment of step (i)a and/or (i)b. Flocculation aids are well known in the art and can be used to assist with removal of the precipitate from the heavy metal-reduced solution.

The following examples demonstrate certain aspects of the methods of the invention.

### EXAMPLE 1

An aqueous solution was prepared to contain about 7060 ppb mercury and 0.68 wt % sodium polysulfide in water. The solution was maintained with an ordinary air headspace for about one month. A light yellow precipitate formed and was removed by filtration. The mercury concentration in the solution after removing the precipitate was 671 ppb, demonstrating a removal of greater than 90 wt % of the mercury in the original solution. The mercury concentration in the removed precipitate was 135 ppm, demonstrating that a majority of the mercury in the original solution was removed in the precipitate.

For comparison, a similar aqueous solution was prepared by adding mercury and sodium polysulfide to water. The solution was maintained with a nitrogen headspace for about 10 days. No precipitate was formed and the concentration of mercury in solution remained unchanged.

### EXAMPLE 2

An aqueous solution containing 22,900 ppb of mercury and 0.68 wt % sodium polysulfide was prepared. Two hundred mL of the solution was placed into a tall form gas washing bottle. Oxygen was sparged at 300 mL/minute through the solution by passing the gas through a glass frit placed at the bottom of the bottle. The frit was used to produce small bubbles through the solution. After about one minute, a yellow-white precipitate began to form. As time progressed, the particles became grey-white in color and began to settle to the bottom of the bottle even though there was significant turbulent lift from the bubbles. After an hour, the purging was stopped and the solution was filtered through a 0.2 μM glass filter. The filtered solution contained 159 ppb mercury. This is a removal of 99.3 wt % of the mercury originally contained in the solution.

### EXAMPLE 3

An aqueous solution containing 22,900 ppb of mercury and 0.68 wt % sodium polysulfide was prepared. Two hundred mL of the solution was placed into a tall form gas washing bottle. Compressed air was sparged at 300 mL/minute through the solution by passing the gas through a glass frit placed at the bottom of the bottle. The frit was used to produce small bubbles. After about one hour, a slight white haze began to form. After two hours, a precipitate began to build up in the bottom of the bottle. After 4 hours, particle formation became very apparent with the precipitate being light yellow in color. After 5 hours, the precipitate was white-grey in color. A sample was withdrawn at this time and the level of mercury was measured to be 222 ppb. The reaction was allowed to continue for another hour (total of 6 hours). The solution was then filtered through a 0.2 μM glass filter. The filtered solution contained 72 ppb mercury. This is a removal of 99.7 wt % of the mercury originally contained in the solution.

Air is approximately 20% oxygen, and the process described in this example took 5 to 6 hours to oxidize the mercury-sulfur complex as compared to the process of Example 2 in which the sparging with oxygen was conducted in one hour to achieve similar mercury removal. This shows that approximately the same amount of oxygen was needed to oxidize and precipitate the mercury complex using either air or oxygen and that oxygen is much more efficient at removing the mercury from solution.

### EXAMPLE 4

An aqueous solution containing 22,900 ppb of mercury and 0.68% sodium polysulfide was prepared. Two hundred mL of the solution was placed into a tall form beaker. Two grams of 50% hydrogen peroxide (providing a ratio of 1.2 moles of peroxide/mole sulfur) were rapidly added to the beaker with a magnetic stirrer set to 400 rpm. A yellow-white precipitate immediately formed. The precipitate rapidly changed color to greenish and finally grey-white. The precipitate tended to drop to the bottom of the solution even with the rapid stirring that was occurring. After one minute, the solution above the precipitate became clear and colorless. The solution was filtered through a 0.2 μM glass filter and analyzed for mercury. No mercury was observed in the solution. The detection limit for mercury used for this test is 10 ppb. Thus, greater than 99.9 wt % of the mercury was removed from solution using hydrogen peroxide as the oxidant.

### EXAMPLE 5

An aqueous solution containing 22,900 ppb of mercury and 0.68 wt % sodium polysulfide was prepared. Two hundred mL of the solution was placed into a tall form beaker. 5.84 grams of potassium persulfate (providing a ratio of 1.2 moles of persulfate/mole sulfur) were rapidly added to the beaker with a magnetic stirrer set to 400 rpm. A yellow-white precipitate immediately formed, followed quickly by turning milky white, and then to a grey-white precipitate, with a clear colorless liquid on top. As with the peroxide treatment described in Example 4, the precipitate dropped to the bottom of the beaker even though rapid stirring was occurring. After one minute, a sample was obtained by filtering some of the solution through a 0.2 μM filter and the sample was analyzed for mercury. The level of mercury was found to be 25 ppb. The reaction was allowed to proceed for 4 more minutes for a total of 5 minutes. After this 5 minute reaction time, the level of mercury in solution was <10 ppb. Thus, potassium persulfate also removed greater than 99.9 wt % of the mercury from the original solution with a reaction time that was slightly slower than the reaction with hydrogen peroxide.

### EXAMPLES 6a-6e

Several other oxidants were evaluated in the same manner as described in Examples 4 and 5, using 1.2 moles of oxidant per mole of sulfur with reaction times up to 40 minutes. The reaction progress is easily monitored visually to observe the relative amount and color of precipitate formed. Most of the reactions were complete after the first few minutes. Nevertheless, the reactions were given 40 minutes to insure the reaction proceeded as far as possible. The results are summarized below.

| | | |
|---|---|---|
| 6a: | Potassium dichromate | 67.95 wt % Hg removed |
| 6b: | Sodium hypochlorite | 22.79 wt % Hg removed |
| 6c: | Potassium perchlorate | 2.10 wt % Hg removed |
| 6d: | Ammonium perchlorate | 4.31 wt % Hg removed |
| 6e: | Potassium permanganate | greater than 99.9 wt % Hg removed |

### EXAMPLES 7a and 7b

An aqueous solution was prepared to contain about 2160 ppb mercury and 0.68 wt % sodium polysulfide in water. In order to simulate real-life conditions, the solution was prepared using a blend of formation water obtained from two different natural gas fields. The formation water contains a large range of different impurities (including C₁-C₃ alkanes), has a relatively high ionic strength due to a high amount of dissolved mineral salts.

Example 7a: To 200 g of the solution described in the preceding paragraph, approximately 2.17 g CO₂ (estimated) was added by bubbling 200 mL/min 20% CO₂ in N₂ through the solution in a dreschel bottle for 30 minutes, thereby resulting in in-situ carbonic acid formation and precipitation of the mercury-sulfur complex. After treatment, the solution was centrifuged for 10 min at 4000 rpm and mercury content measured in the supernatant. The mercury content of the solution was <10 ppb, meaning a removal of greater than 99.9 wt % of the mercury from the original solution was achieved via acidification. The pH of the solution after treatment was 7.

Example 7b: To 90 g of the solution described above, 5 g of glacial acetic acid was added. This resulted in a vigorous reaction and almost immediate precipitation of the mercury-sulfur complex. After treatment, the mercury content of the solution was <10 ppb, meaning a removal of greater than 99.9 wt % of the mercury from the original solution was achieved via acidification. The pH of the solution after treatment was 3.

Similar tests using a strong acid (HCl) in similar molar concentration showed that removal of at least about 50% of mercury from solution is possible (non-optimized) but that weak acids appear to outperform strong acids. In particular, it showed that pH is not the sole determining factor, since HCl in an amount resulting in a pH as low as 1 exhibited significantly less precipitation of the mercury-sulfur complex than the two weak acid tests described above.

The specific embodiments and examples described in the present disclosure are illustrative only in nature and are not limiting of the invention defined by the following claims. Further aspects, embodiments and advantages of the invention will be apparent in view of the present disclosure and are encompassed within the following claims.

What is claimed is:

1. A method for removing a soluble heavy metal-sulfur complex from an aqueous or glycol process solution, the method comprising comprising the steps of:
(i)a contacting the process solution with an oxidant to oxidize the heavy metal-sulfur complex and form an oxidized complex precipitate; and/or
(i)b contacting the process solution with an acid, preferably a weak acid, to precipitate the heavy metal-sulfur complex and form an acidified complex precipitate; and
(ii) removing the precipitates from the process solution to provide a heavy metal-reduced process solution.

2. The method of claim 1, wherein the heavy metal-sulfur complex comprises one or more sulfide complexes of elemental mercury, cadmium, barium, iron, vanadium and/or manganese.

3. The method of claim 2, wherein the heavy metal-sulfur complex comprises a mercury-sulfide complex.

4. The method of claim 1, wherein the heavy metal-sulfur complex is the reaction product of a heavy metal and an inorganic alkaline, alkaline earth and/or ammonium polysulfide.

5. The method of claim 4, wherein the heavy metal-sulfur complex is the reaction product of a heavy metal and calcium, sodium, potassium and/or ammonium polysulfide.

6. The method of claim 4, wherein the polysulfide has from 2 to 5 sulfide anions.

7. The method of claim 1, wherein the contacting step (i)a is conducted with a stirred tank reactor with one or more agitators, inline high shear and/or high impacting mixing equipment, a tank with cavitation technology, a tubular reactor, sparging, or a combination of two or more thereof.

8. The method of claim 7, wherein the contacting step (i)a is conducted in a stirred tank reactor with one or more of impellers, turbines and/or blades, bubble columns, packed columns, tray columns, spray columns, jet loops, a cavitation propeller or distributor, a cavitational pump, a tubular reactor, and sparging.

9. The method of claim 1, wherein the contacting step (i)a comprises sparging the process solution with an oxidant.

10. The method of claim 1, wherein the oxidant comprises one or more of air, oxygen, ozone, persulfate salts, permanganate salts, inorganic peroxides and/or organic peroxides.

11. The method of claim 1, wherein the acid is a weak acid, preferably a weak acid having a molecular weight of less than 300 g/mol and a pKa of less than 12, preferably a pKa in the range of 3-11, more preferably a pKa in the range of 3-8, most preferably a pKa in the range of 3.5-6.

12. The method of claim 1, wherein the acid is selected from the group consisting of acetic acid, carbonic acid, oxalic acid, hydrogen oxalate, citric acid, dihydrogen citrate, hydrogen citrate, fumaric acid, hydrogen fumarate, maleic acid, hydrogen maleate, succinic acid, hydrogen succinate, itaconic acid, hydrogen itaconate, p-toluenesulfonic acid, ammonium chloride, sulfurous acid, bisulfites, phosphoric acid, dihydrogen phoshates, hydrogen phosphates, boric acid, bisulfates, nitrous acid, formic acid, benzoic acid and combinations thereof, preferably selected from formic acid, citric acid, acetic acid, carbonic acid and combinations thereof.

13. The method of claim 1, wherein step (i)a is performed.

14. The method of claim 1, wherein the removing step (ii) comprises one or more of filtration, flotation, thickening, membrane separation, field assisted separation, and/or centrifugation.

15. The method of claim 14, wherein the filtration comprises microfiltration and/or ultrafiltration, the flotation comprises dissolved air flotation, the thickening comprises a sedimentation, hydrocyclonic, cross flow filtration, and/or gravity technique, and/or the field assisted separation comprises a magnetic, electric, dielectric, and/or acoustic field.

16. The method of claim 1, wherein, after removal of the precipitate from the process solution in step (ii), the heavy metal-reduced solution is contacted with an ion exchange resin to remove at least a portion of remaining heavy metal-sulfur complex.

17. The method of claim 1, wherein the heavy metal-reduced solution comprises less than about 80 wt %, less than about 85 wt %, less than about 90 wt %, less than about 95 wt %, or less than about 99 wt %, of the heavy metal contained in the process solution.

18. The method of claim 1, wherein the heavy metal-reduced solution comprises less than about 5000 ppb, less than about 4000 ppb, less than about 3000 ppb, less than about 2000 ppb, or less than about 1000 ppb heavy metal.

19. The method of claim 1, wherein the process solution further comprises a thermodynamic inhibitor to decrease the temperature at which heavy metal in the process solution forms a hydrate.

20. The method of claim 1, wherein the process solution originates from a natural gas production process.

21. The method of claim 20, wherein the process solution comprises an aqueous process solution.

22. The method of claim 20, wherein the process solution comprises a glycol process solution.

23. The method of claim 1, wherein the process solution originates from a petroleum production process.

24. The method of claim 1, wherein the process solution comprises an aqueous process solution and originates from a water treatment process.

25. The method of claim 1, wherein the process solution comprises an aqueous process solution and originates from a non-precious metal mining process.

26. The method of claim 1, wherein a flocculation aid is added after the treatment of step (i)a and/or (i)b.

27. The method of claim 1, where a flocculation aid is added before the treatment of step (i)a and/or (i)b.
